(19) United States
(12) Patent Application Publication
(10) Pub. No.: US 2006/0236066 A1
(43) Pub. Date: Oct. 19, 2006

(54) Method for controlling a digital storage unit

(76) Inventor: Jean-Luc Walem, Mons (BE)

Correspondence Address: YOUNG & THOMPSON, 745 SOUTH 23RD STREET, 2ND FLOOR, ARLINGTON, VA, 22202, US

(21) Appl. No.: 10/560,164

(22) PCT Filed: Jun. 8, 2004
(86) PCT No.: PCT/FR04/01417

§ 371 Date: Apr. 24, 2006

(30) Foreign Application Priority Data
Jun. 10, 2003 (FR) 0306938

(51) Int. Cl. G06F 12/00

(52) U.S. Cl. 711/173

(57) ABSTRACT

The invention relates to a process for management of a digital storage unit (2) divided into sectors, especially in view of its backup. This process comprises the stages that consist in: creating a first table (M1), each element of which corresponds to one sector of the storage unit; initializing said first table; during a first modification of a sector after said initialization, modifying the element of the first table corresponding to this sector; not modifying an element of the first table during a modification of the sector that corresponds to it if the element has already been modified; reinitializing said first table during the occurrence of a first predetermined event.

The invention relates to a process for management of a digital storage unit, especially with respect to its backup, and more especially such a unit divided into sectors.

First of all, it is recalled that there are three types of backup for a storage unit:
complete backup. This backup provides a physical image of the storage unit;
partial backup. This consists in saving changes since the last complete backup.
This backup mode makes it possible to quickly restore the storage unit, but does not make it possible to go back in time;
   incremental backup. This consists in saving the change since the last incremental backup (the complete backup being the incremental backup of the first level). This backup mode makes complete rebuilding of the unit slower, but makes it possible to go back in time.

Moreover, with respect to information science, the size of the hard disks (direct access data storage units) does not stop increasing, whereas the backup units develop more slowly.

This engenders both an economic problem, in view of the increased cost of backup units relative to that of hard disks, and a technical problem, in view of the overly long duration of backup operations and often the need to distribute the latter among several physical media with the operator manipulations that this involves.

To circumvent these problems, more and more often, a second hard disk is used for backing up data, but this technique entails several disadvantages:

in case of theft or fire, the loss of the computer entails simultaneous disappearance of the data and the backup;

there is only a single backup level with the impossibility of going back in time to restore a prior situation.

On the other hand, the increase of speeds on the Internet (Ex: ADSL) allows use of this medium for “remote” backups. Likewise there, the magnitude of the data volume engenders a problem. Actually, the duration of a backup via the Internet determines its cost and can even make it physically impossible.

To circumvent these problems, only files altered since the last complete backup are saved, but there too the method entails several disadvantages:
If a very large file has been modified, the complete file will be saved, while the modification often applies only to a small portion of the latter. There are software solutions for circumventing this problem, but they are extremely complex to implement and require major hardware resources;
the backup problem depends on the operating system (OS). Thus, a backup program must be written for each supported OS. Taking into account the presence of several partitions with different OS on the same computer is not possible;
complete restoration of the computer is often made very complex by the operating system. For example, the restoration of registers of certain OS is particularly sensitive;
the deleted files must be managed by the backup program because they will be undesirably restored on the hard disk in case of reloading of the initial complete backup;
real time backup, i.e., during normal use of the hard disk, is impossible or extremely difficult to program. This disadvantage, even if it is not annoying to the PC user, can be so for the backup service provider via the Internet. Actually, this operator will only essentially be able to use a few hours of daily inactivity for backing up a very large number of computers.

This invention is intended to solve these problems.

More especially, the purpose of the invention is to effect the possibility of carrying out backups of a storage unit with the following characteristics:
independence relative to the software (operating system);
saving of volume (amount of data) and time for backup operations;
minimum blocking of the unit during the backup (essentially in real time).

The principle of the invention is to develop a technique that allows the controller of the storage unit to automatically maintain a card of the modified sectors in order to enable management of backups by sectors rather than by files.

This principle will make it possible to achieve the intended objectives to the extent:
the sector is a physical concept and thus is independent of the operating system used;
knowing the sectors that have been modified, it will be possible to save only data that have been “physically” modified in order to save volume and time;
finally, based on the principle that the table of modified sectors is dynamically managed by the controller, it will be possible to carry out backups essentially in real time.

First of all, the object of the invention is a process for management of a digital storage unit divided into sectors, especially in view of its backup, characterized in that it comprises the following stages that consist in:
creating a first table, each element of which corresponds to one sector of the storage unit;
initializing said first table;
during a first modification of a sector after said initialization, modifying the element of the first table corresponding to this sector;
not modifying an element of the first table during a modification of the sector that corresponds to it if the element has already been modified;
reinitializing said first table during the occurrence of a first predetermined event.

Creation and initialization of said first table can take place during the formatting of the storage unit.

Said first table is reinitialized especially during a complete or incremental backup of the storage unit.

In one particular embodiment of the invention, the process comprises a stage that consists in creating and keeping a copy of said first table, and reinitializing said copy during the occurrence of a second predetermined event.

Said copy is then reinitialized especially during a partial backup of the storage unit.

Likewise, in one particular embodiment of the invention, the process comprises the stages that consist in:
creating a second table, each element of which corresponds to one group of sectors of the storage unit;
initializing said first table;
during a first modification of a sector of a group of sectors after said initialization, modifying the element of the second table corresponding to this group of sectors;
not modifying an element of the second table during a modification of one sector of a group of sectors that corresponds to it if the element has already been modified;
reinitializing said second table during the occurrence of said first predetermined event.

Creation and initialization of said first table can take place during the formatting of the storage unit.

Said second table is reinitialized especially during a complete or incremental backup of the storage unit.

In one particular embodiment of the invention, the process of the stage consists in creating and keeping a copy of said second table, and reinitializing said copy during the occurrence of a second predetermined event.

Said copy is reinitialized especially during a partial backup of the storage unit.

Said first table can be created on said storage unit.

Conversely, said second table can be created in the read-write memory in the controller of said storage unit.

The object of the invention is likewise a process for complete or incremental backup of a digital storage unit divided into sectors, characterized by the fact that the storage unit is managed by a process such as is described above, and that comprises the stages consisting in:
saving the indicated sectors as modified in said first table one after the other;
reinitializing as the elements of said first table correspond to the saved sectors.

The object of the invention is likewise a process for partial backup of a digital storage unit divided into sectors, characterized by the fact that the storage unit is managed by a process such as is described above, and that comprises the stages consisting in:
saving the indicated sectors as modified in said first table one after the other;
reinitializing as the elements of the copy of said first table correspond to the saved sectors.

The object of the invention is likewise a controller of the digital storage unit divided into sectors, characterized by the fact that it is arranged to implement a process such as described above.

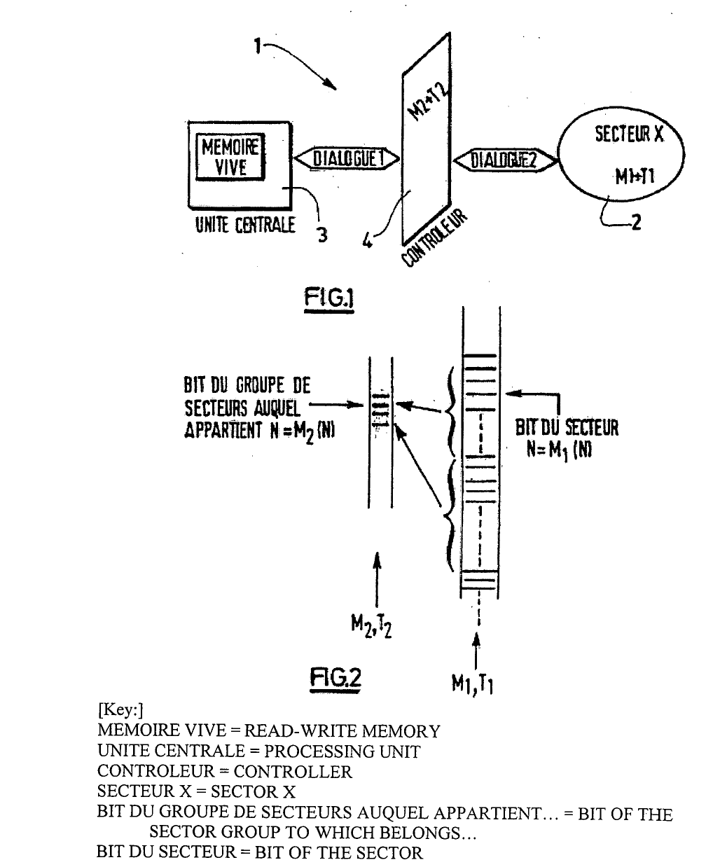

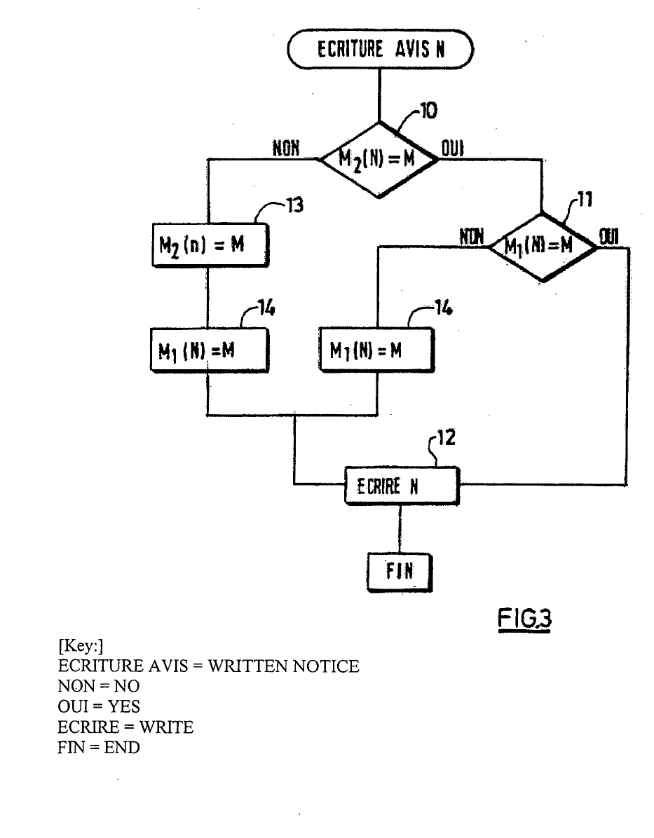

Using a nonlimiting example, one particular embodiment of the invention will now be described, with reference to the attached schematic drawings in which:
FIG. 1 illustrates a computer whose storage unit is managed according to the invention;
FIG. 2 illustrates the tables used to manage the storage unit; and
FIG. 3 is a flow chart of a writing operation on the storage unit.

If the current operation of a computer 1 at the level of management of its storage unit 2 (hard disk, RAID . . . ) is considered, the processing unit 3 contains in its read-write memory the programs and data during processing. The disk controller card 4 is the physical interface between the processing unit and the storage unit. For this, the controller interacts, on the one hand, with the processing unit (dialogue 1) and, on the other hand, with the storage unit (dialogue 2) that is divided into “sectors.” The size of the sector is the elementary amount of data that can be exchanged in one operation between the controller and the storage unit (often 512 octets).

From a practical viewpoint, these dialogues proceed as follows:
if the processing unit 3 requires data contained in sector X of the storage unit 2, it requests the controller 4 to read this sector X. The controller takes responsibility for physically executing this request and sends the result (512 octets) to the processing unit 3;
for writing, the operation is the reverse. The processing unit 3 sends the new contents of sector X to the controller 4 and asks it to write these contents to address X. The controller takes responsibility for physically executing this request.

The storage unit 2 contains here two tables M1 and T1, and the controller 4 contains two tables M2 and T2. M1 is a card of the modified sectors and T1 is a temporary card similar to M1. Tables M2 and T2 ensure that locations are rapidly found in tables M1 and T1.

Actually, to be able to implement a partial (nonincremental) backup in real time, it is necessary to have a temporary table T1 identical to M1 as well as a second level table T2 identical to M2, in order to preserve one card of the changes made since the last complete backup.

FIG. 2 shows that tables M1 and T1 are streams of bits M1 (T),T1 (N) in which the bit of order N is linked to the sector of address N of unit 4. Tables M2 and T2 are likewise streams of bits M2(N), T2(N), of which the bit of order N is linked to an Nth group of sectors.

The first command specific to the invention that is added to dialogue 1 is a specific formatting request (in a mode that will later be called the “ASM mode”) of the storage unit 2. The dialogue 2 will allow the controller to carry out this formatting in order to reserve space for M1 and T1 by reducing the number of sectors that can actually be used for the data. This number as well as an “ASM marker” will be written at the start of table M1 to allow the controller to recognize the type of format.

It is important to point out that the space necessary for storage of M1 and T1 will be approximately one-half of one-thousandth of the total space. The capacity of a storage unit formatted in the ASM mode will thus be essentially identical to that of a unit in a conventional format.

The read-write memory space necessary on the controller for managing tables M2 and T2 will for itself be quite negligible (a few Ko).

To remain compatible with conventional operation, the controller card 4 must, of course, continue to take responsibility for reading and writing of a sector N by the processing unit.

If the disk has not been formatted in the ASM mode, the operation is carried out exactly as in the case of a standard controller. In the opposite case, the tables having been initialized during the last backup as will be described below, the operation is broken down as shown in FIG. 3.

The state of the sector N, already declared changed or unchanged, is determined in 10 and 11 with M1, M2 (or T1 and T2).

If the sector has already been changed, writing in 12 is initiated.

In the opposite case, tables M1, M2, T1 and T2 are updated in 13 and 14 to mark the sector N as modified, and the sector N is written.

For reading of a sector N, a supplementary operation is not necessary, except for the different localization of sector N depending on whether the storage unit is formatted in the ASM mode or not.

From a practical viewpoint, tables M2 and T2 can be rebuilt based on M1 and T1, but this operation requires several seconds for complete reading of M1 and T1 on the storage unit. In addition, to avoid as much as possible this loss of time, a command (dialogue 1) is added to be able to store the tables of the second level M1 and T2 on the storage unit at the instant the latter physically stops. During startup, a marker makes it possible to know if tables M2 and T2 must be rebuilt or simply read.

At this stage, a means is therefore available that makes it possible to know if a sector N has been modified or not. It must now be determined how to implement the backups and to ensure the return to the unchanged state for a sector.

In order to automate the three aforementioned types of backup as much as possible, three commands are added to dialogue 1 that allow the controller to be placed in the desired backup mode and ensure that internal operations are carried out via dialogue 2 until the end of the backup. The return to the normal state then takes place automatically, and resetting to the “unmodified” state for the saved sectors is likewise transparent for the processing unit.

Once the system has been placed in a backup mode, a supplementary command is used to provide the next sector to be saved to each request originating from the processing unit or to signal the end of the backup.

To save, even in the complete mode, only the parts of the storage unit that have actually been used, a repetition counter is provided with the sector to be saved. For example, if, after formatting a zone of the unit, this zone contains all identical sectors, then the saving of this zone requires only the backup of its first sector and the number of sectors that comprise it.

To allow backup in real time, one command gives the number of sectors remaining to be saved and another command makes it possible to block and unblock the storage unit relative to writing requested by the processing unit. In this way, the backup system can follow the development of the number of sectors remaining to be saved, and in case of an overly slow reduction in number, can temporarily block the storage unit.

Commands likewise allow the writing of a backup program for a particular operating system while allowing a benefit to be drawn from the knowledge of the modified sectors.

Such a program loses some of the advantages of the ASM mode such as independence relative to the operating system, but allows more standard management of the files.

Moreover, the use of a cache memory specific to M1 that likewise improves overall performance can be provided.

The commands that the controller must manage will now be summarized.

1) Specific formatting of the storage unit.

Let NS be the number of data sectors available after this formatting.

Let NSM be the number of unsaved sectors (at the start, NSM=NS).

2) Give the number of data sectors (NS).

3) Move into the complete backup mode.

Mark all the sectors as modified (NSM=NS).

Remain in this mode as long as NSM>0.

4) Move into the partial backup mode and remain there as long as NSM>0.

5) Move into the incremental backup mode and remain there as long as NSM>0.

6) Give the address X (1≦X≦NS, 0=END) of the next sector indicated as modified, the number of successive repetitions (N) and the contents of this sector.

Decrement NSM from N+1.

In the complete or incremental backup mode, reinitialize element X to X+N of table M1 such that the saved sectors are no longer indicated as modified.

Remember that there is a “successive repetition” for sector X if the next modified sector is X+1 and that the contents of sectors X and X+1 are identical.

7) Give the number of remaining modified sectors (NSM).

8) Block/unblock the unit being written.

9) Rewrite a sector based on its address X (1 to NS) and its contents during blocking of the unit (possibly with a repetition factor N).

10) Stoppage of the unit.

11) Give the state of a sector or a group of related sectors. The response is the number of sectors marked as modified.

12) Direct management of tables M1 and T1 with automatic updating of M2, T2 and NSM.

The command 1 makes it possible to preserve cards M1 and T1 of the modified sectors on the unit itself. Memories T1 and M1 are distributed on the physical unit so as to minimize its updating time following modification of a data sector.

Marking is provided (in the zone reserved for M1, T1, . . . ) to allow recognition of the special ASM format, and an additional space is provided to replace a sector that would become defective.

Commands 3 to 8 make it possible to accomplish the three types of backup of the unit while minimizing its writing non-availability. Actually, if saving several versions of the same sector is approved, it is not necessary to block the unit during the entire backup operation.

Moreover, taking into account the repetitive sectors makes it possible to physically save only the portions actually used on the storage unit.

On the unit itself, the command 10 allows saving of the secondary table M2 and the NSM counter that are managed in the read-write memory by the controller. Thus, it is possible to avoid rebuilding this secondary table during restart of the storage unit by the controller.

Commands 11 and 12 make it possible to write backup/ restoration programs for a particular operating system.

It will be noted that it is always possible to encrypt and compress the saved data so as to protect and enhance the performance levels of the operation.

Some applications of the invention are given below by way of example.

1) Possibility of rebuilding or duplicating a storage unit without having to have it recognized by an operating system. Moreover, the new storage unit can have a greater capacity than the old one without any software manipulation being necessary.

2) Possibility of producing physical backup units that are independent of any operating system.

3) Possibility of economically managing the backup of several PCs on one server (local or remote) independently of the operating systems, with the possibility of returning from 1 to X days back.

To do this, we start from an image of the PC that is being preserved in an image file F1. Each day, the incremental backup is preserved in a file Fn. For reconstituting a situation after n days from the initial backup, it will be enough to “replay” F1 to Fn on a copy of Fi.

When the number of incremental backups arrives at X (desired number of days of history), it is enough to replace Fi by Fi+F1 (“replay” F1 on Fi) and to erase F1 (F2 becomes F1, . . . ).

4) Possibility of globally managing the backup of a disk supporting several OS.

5) Possibility of minimizing the disadvantages resulting from use of a physical backup unit (tape) of less capacity than the total volume of the storage unit, for example keeping the backups of a 100 Gb disk using a 40 Gb tape.

6) Possibility of using the invention in a conventional program written for a given operating system. In this case, the gains in space and time are preserved with the possibility, moreover, of working at the level of the “file” itself on sequential media (tape).

To do this, the list of files (directory) with a link to the sectors (via the “clusters” of the OS) is placed at the head of the backups (complete, partial or incremental).

Generally, it will be noted that due to independence relative to software, there is a risk of producing an “image” backup of the storage unit at a given instant that is not stable from the software standpoint. If the backup is done by the OS, however, it can be left responsible for stability at this instant. Otherwise, the backup can be effected outside of use of the unit.

Moreover, in the case on physical backups on a sequential medium (tape), it may be difficult to reload one part (for example, a particular file) of the storage unit. A first solution is to reload the initial+partial backup as an “image” file onto another direct access storage unit, thus to use software that recognizes the type of partition used to extract the desired data. Another solution consists in using a program written for the operating system managing the unit to be backed up.

1. Process for management of a digital storage unit (2) divided into sectors, especially in view of its backup, characterized by the fact that it comprises the stages that consist in:
creating a first table (M1), each element of which corresponds to one sector of the storage unit,
initializing said first table;
during a first modification of a sector after said initialization, modifying the element of the first table corresponding to this sector;
not modifying an element of the first table during a modification of the sector that corresponds to it if the element has already been modified;
reinitializing said first table during the occurrence of a first predetermined event.

2. Process according to claim 1, wherein the creation and initialization of said first table takes place during the formatting of the storage unit.

3. Process according to any of claims 1 and 2, wherein reinitialization of said first table takes place during a complete backup of the storage unit.

4. Process according to any of claims 1 and 2, wherein reinitialization of said first table takes place during an incremental backup of the storage unit.

5. Process according to any of claims 1 to 4, comprising the stage consisting in creating and keeping a copy (T1) of said first table, and in reinitializing said copy during the occurrence of a second predetermined event.

6. Process according to claim 5, wherein reinitialization of said copy takes place during a partial backup of the storage unit.

7. Process according to any of claims 1 to 6, comprising the stages that consist in:
creating a second table (M2), each element of which corresponds to one group of sectors of the storage unit;
initializing said first table;
during a first modification of one sector of a group of sectors after said initialization, modifying the element of the second table corresponding to this group of sectors;
not modifying an element of the second table during a modification of one sector of a group of sectors that corresponds to it if the element has already been modified;
reinitializing said second table during the occurrence of said first predetermined event.

8. Process according to claim 7, wherein the creation and initialization of said second table takes place during the formatting of the storage unit.

9. Process according to any of claims 7 and 8, wherein the reinitialization of said second table takes place during a complete backup of the storage unit.

10. Process according to any of claims 7 and 8, wherein reinitialization of said second table takes place during an incremental backup of the storage unit.

11. Process according to any of claims 7 to 10, comprising the stage consisting in creating and keeping a copy (T2) of said second table, and in reinitializing said copy during the occurrence of a second predetermined event.

12. Process according to claim 11, wherein the reinitialization of said copy takes place during a partial backup of the storage unit.

13. Process according to any of claims 1 to 12, wherein said first table is created on said storage unit.

14. Process according to any of claims 7 to 13, wherein said second table is created in the read-write memory in the controller of said storage unit.

15. Process for complete or incremental backup of a digital storage unit (2) divided into sectors, wherein the storage unit is managed by a process according to any of claims 1 to 14, and wherein it comprises the stages consisting in:
saving the indicated sectors as modified in said first table one after the other;
reinitializing as the elements of said first table correspond to the saved sectors.

16. Process for partial backup of a digital storage unit (2) divided into sectors, wherein the storage unit is managed by a process according to any of claims 5, 6, 11 and 12, and wherein it comprises the stages consisting in:
saving the indicated sectors as modified in said first table one after the other;
reinitializing as the elements of the copy of said first table correspond to the saved sectors.

17. Controller (4) of the digital storage unit divided into sectors, wherein it is arranged to implement a process according to any of claims 1 to 16.
